(19) United States
(12) Patent Application Publication
(10) Pub. No.: US 2015/0154882 A1
(43) Pub. Date: Jun. 4, 2015

(54) Window Decoration Kit and Method of Application Thereof

(71) Applicant: Cheryl L. Walker, Venice, CA (US)

(72) Inventor: Cheryl L. Walker, Venice, CA (US)

(21) Appl. No.: 14/097,055

(22) Filed: Dec. 4, 2013

(51) Int. Cl. G09B 19/00; B44C 1/10; B44F 1/06

(52) U.S. Cl. CPC G09B 19/0023; B44F 1/06; B44C 1/10

(57) ABSTRACT

A window decoration kit for adding various tinting effects to a back-lit window or other transparent panel without the use of adhesives and/or chemicals, the window decoration kit has a plurality of colored film sets of different colors, each colored film set further consists of a colored vinyl film, a clear acetate film and a white paper backing.

### RELATED APPLICATIONS

None.

### FIELD OF THE INVENTION

This invention relates to a window decoration kit, and more particularly, to adherable, multi-colored vinyl cut-outs of various shapes and sizes for easy positioning and repositioning for decorating any clear window in a creative, unique manner.

### BACKGROUND OF THE INVENTION

A common glass window treatment is window film. There are many types, grades, shades, colors and thicknesses of window films available today. As best shown in FIG. 1, window films 90 are a retrofit upgrade for existing glass that can be used to address a range of problems inherent to glazing, such as but not limited to heat and glare reduction, thermal insulation, UV filtration, safety and security, privacy, decoration, graffiti protection. Window films 90 are typically one-sided and available in regular shapes and sizes such as rectangle, square, circle, oval, etc., to match most windows in autos, homes and buildings. They are usually made of transparent or translucent plastic materials bearing printed decorative patterns, creating an effect similar to stained glass or Tiffany glass. A common application method is using transparent, permanent adhesive which is applied on the back of the window films 90. Once the window films 90 are adhered to the windows and/or other glass panels, they are very difficult to detach without causing damages to the films 90, making repositioning and reuse of window films 90 impossible.

### ADVANTAGES AND SUMMARY OF THE INVENTION

The present invention relates to a window decoration kit that allows users to create their own colored pattern designs on windows. The two-sided color cut-outs which take inspiration from the Matisse cut-outs created and made famous by French artist Henri-Émile-Benoît Matisse can be applied, repositioned and overlapped based on predetermined designs or users' own creative designs, without any adhesive or chemicals. In addition, the present invention can be easily incorporated into an educational game that teaches children or adults the basic concepts of shapes, color combinations, abstraction, balance, etc., in 2D design. Applicant submits that there is no window decoration kit found in the marketplace similar to the present invention.

One object and advantage of the present invention is to provide an easier and more convenient way to decorate a back-lit glass window/panel.

Another object and advantage of the present invention is to provide a basic design kit for users to decorate glass window/panels with unique designs based on their creativity.

Yet another object and advantage of the present invention is to provide a more versatile and flexible window decoration treatment by repositioning and reusing decorative pieces.

Yet another object and advantage of the present invention is to eliminate the use of adhesive and chemical that makes the application of window films difficult and inflexible.

Yet another object and advantage of the present invention is to allow users to change their window decoration designs as often as desired without buying new window films and/or window decoration kits.

Yet another object and advantage of the present invention is to provide a decoration kit to windows/glass panel of all sizes.

Yet another object and advantage of the present invention is to provide an opportunity to teach children and/or adults and allow them to explore the basic design elements of shapes, color combinations.

Further details, objects and advantages of the present invention will become apparent through the following descriptions, and will be included and incorporated herein.

### BRIEF DESCRIPTION OF THE DRAWINGS

FIG. 1 is a representative view of a conventional window film treatment 90 [prior art].

FIG. 2 is a representative isometric view of an embodiment of a colored film assembly 300 of window decoration kit of the present invention 100.

FIG. 3A is a representative top view of an embodiment of colored die-cut film 104 of the present invention 100. FIG. 3B is a representative top view showing cut-outs 120 detached from colored die-cut film 104.

FIG. 4 is a representative top view of an embodiment of paper backing 108 of the present invention 100.

FIGS. 5A and 5B are representative views of method of use of window decoration kit of the present invention 100 showing overlapping of cut-outs 120.

FIGS. 5C and 5D are representative views of an alternative method of use of window decoration kit of the present invention 100.

FIG. 6 is a representative view of method of use of window decoration kit of the present invention 100 showing the completed window decoration.

FIG. 7 is a representative view of method of use of window decoration kit of the present invention 100 utilized as an interactive education game.

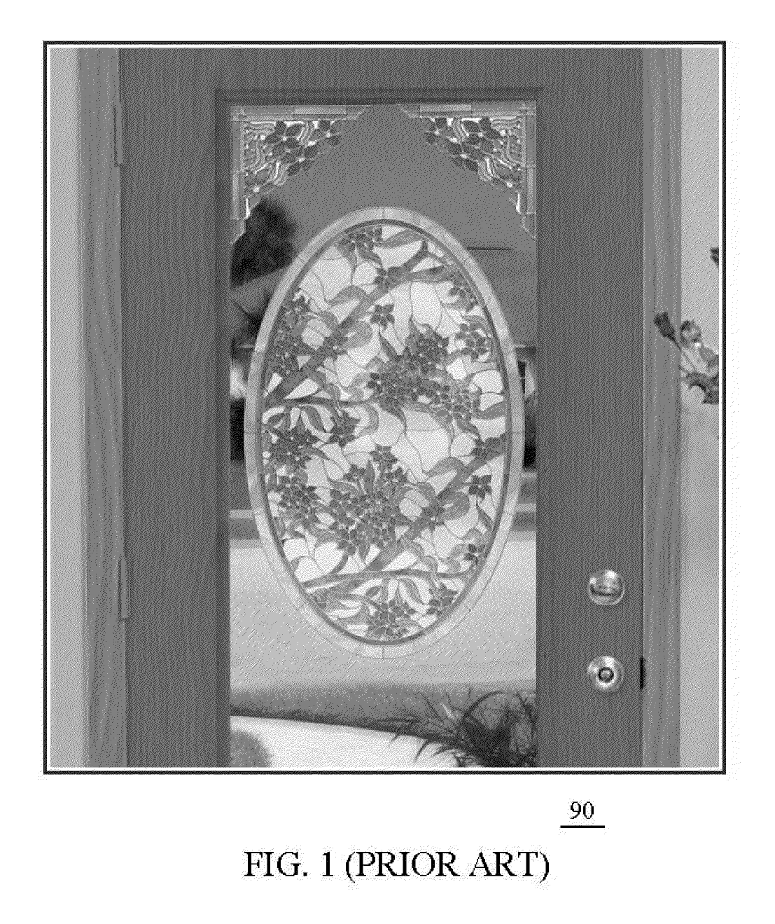

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

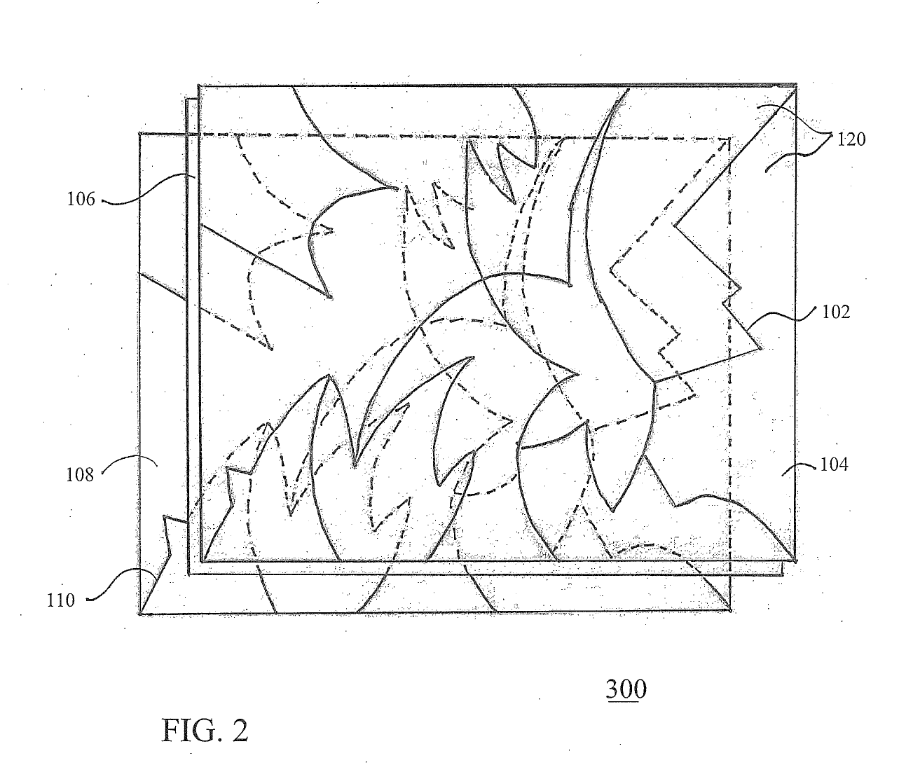

FIG. 2 is a representative isometric view of an embodiment of a colored film assembly 300 of window decoration kit of the present invention 100. In one embodiment, each window decoration kit 100 has a plurality of colored film assemblies 300 and each colored film assembly 300 further consists essentially of a colored die-cut film 104 on top of a paper backing 108, optionally separated by a clear acetate film 106. In one embodiment, the common size of colored die-cut film 104, paper backing 108, and clear acetate film 106 is 8.5″×11″, or more or less.

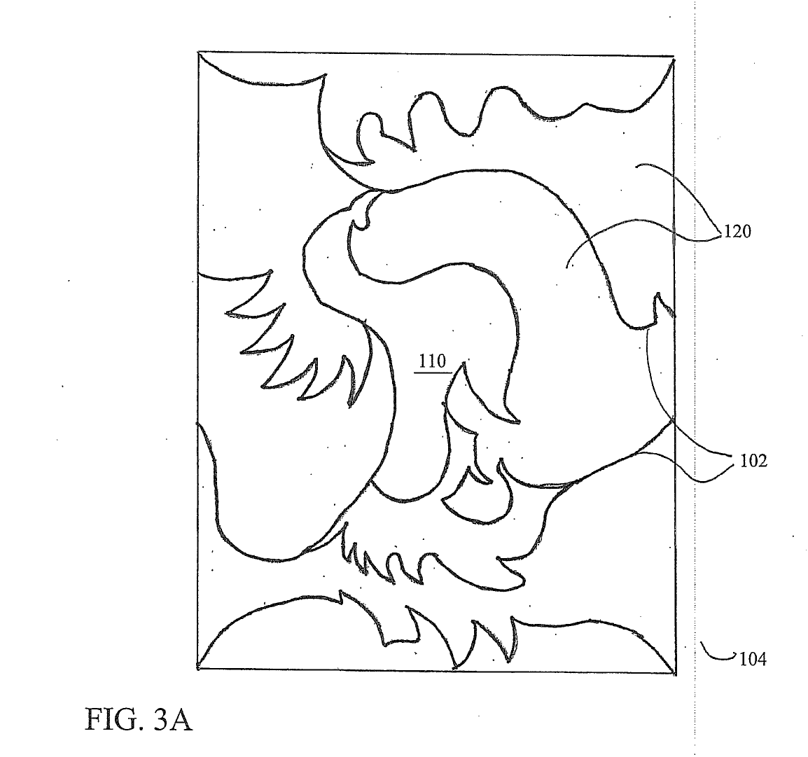

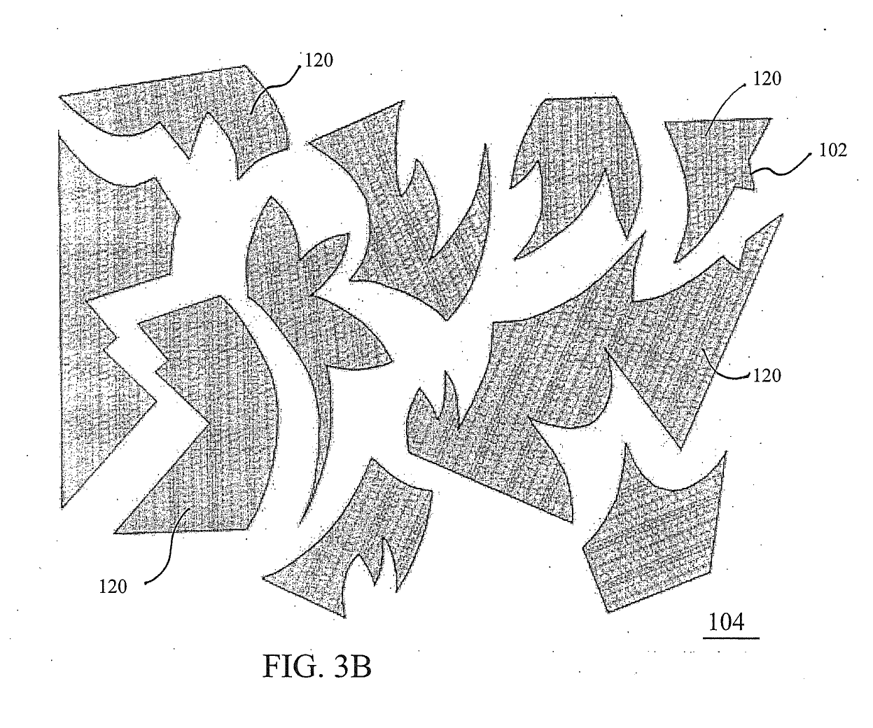

FIG. 3A is a representative top view of an embodiment of colored die-cut film 104 of the present invention 100. In one embodiment, colored die-cut film 104 is made with 6-60 gauge, preferably 9 to 12 gauge, fluorescent colored tinted clear plastic vinyl and/or 100% poly vinyl chloride for its flexibility and waterproofing nature. In one embodiment, the thickness of 9 gauge tinted transparent plastic vinyl is 0.009″ (±5%), 10 gauge is 0.010″ (±5%), 11 gauge is 0.011″ (±5%) and 12 gauge is 0.012″ (±5%). The original material usually comes in the form of a 54″ wide roll which is subsequently cut into the 8.5″×11″ customized size. In alternative embodiments, a variety of sizes of colored die-cut film 104′ can be produced. In one embodiment, each colored die-cut film 104 is translucent in nature which allows light to come through partly and is tinted with different colors such as red, orange, pink, purple, blue, green, crimson, yellow and smokey grey. Due to its material and method of construction, light weight and preferable thickness between 0.009″ to 0.012″, colored die-cut film 104 can be adhered to any clean or essentially clean glass, plexiglass and/or acetate surfaces and/or each other. Due to the translucent nature of colored die-cut film 104 and cut-outs 120, when they are overlapping, a new shade of color different than either one of the individual cut-outs 120 separately will be produced.

As best shown in FIG. 3A, a design pattern was created as shown by cut-out perimeters 102, making colored die-cut film 104 an assembly of geometric shaped cut-outs 120. Cut-out perimeters 102 are created by the die cutting process and consequently each cut-out 120 is completely detachable from colored die-cut film 104. In one embodiment, each colored die-cut film 104 has a different design pattern 110 such as standard geometric shapes or a combination of squares, circles, ovals, abstract shapes, customized shapes such as Matisse cut-outs, etc. Some colored die-cut films 104 may feature no design pattern 110 so they can be used as a colored background or foreground in an overall design. As best shown in FIG. 2, after die cutting, colored die-cut film 104 is optionally placed on clear acetate film 106 as the static charge between the two films 104 and 106 helps hold colored die-cut film 104 as one piece so cut-outs 120 do not disengage from the film 106 easily prior to removal by a user.

FIG. 3B is a representative top view showing cut-outs 120 detached from colored die-cut film 104. As explained, since the design pattern is die cut, cut-outs 120 can easily be detached from colored die-cut film 104. Depending on the design pattern 110, each cut-out 120 is in an unique shape as best shown in FIG. 3B. In one embodiment, cut-outs are reversible, i.e., users can use both sides of cut-outs 120 to complete their own design on a window/glass panel 80.

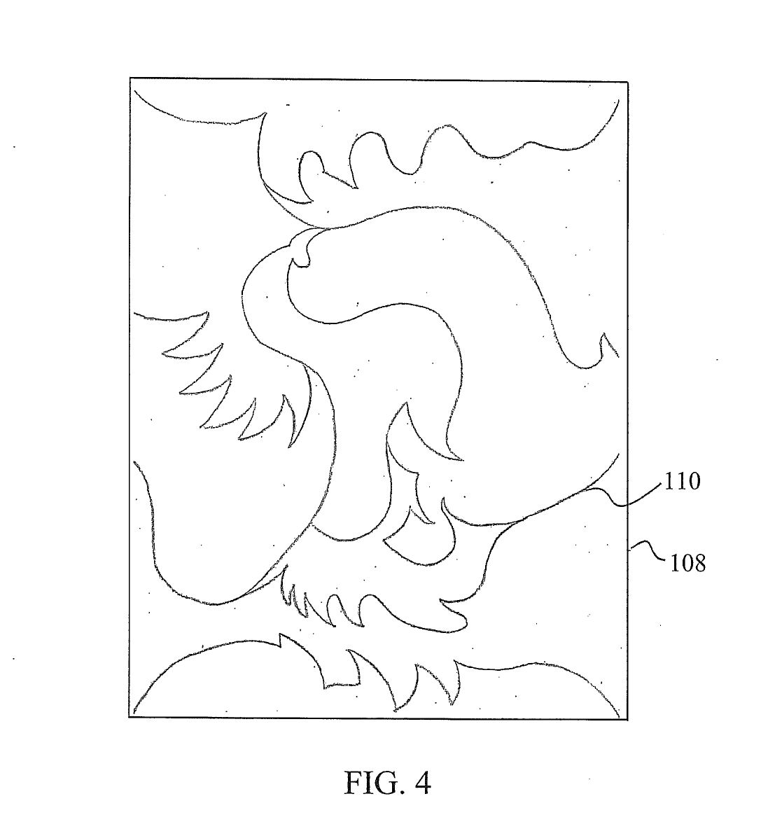

FIG. 4 is a representative top view of an embodiment of paper backing 108 of the present invention 100. In one embodiment, paper backing 108 is a piece of white paper with the design pattern 110 printed on. It helps users to put back cut-outs 120 together according to the printed design pattern 110 if they choose to.

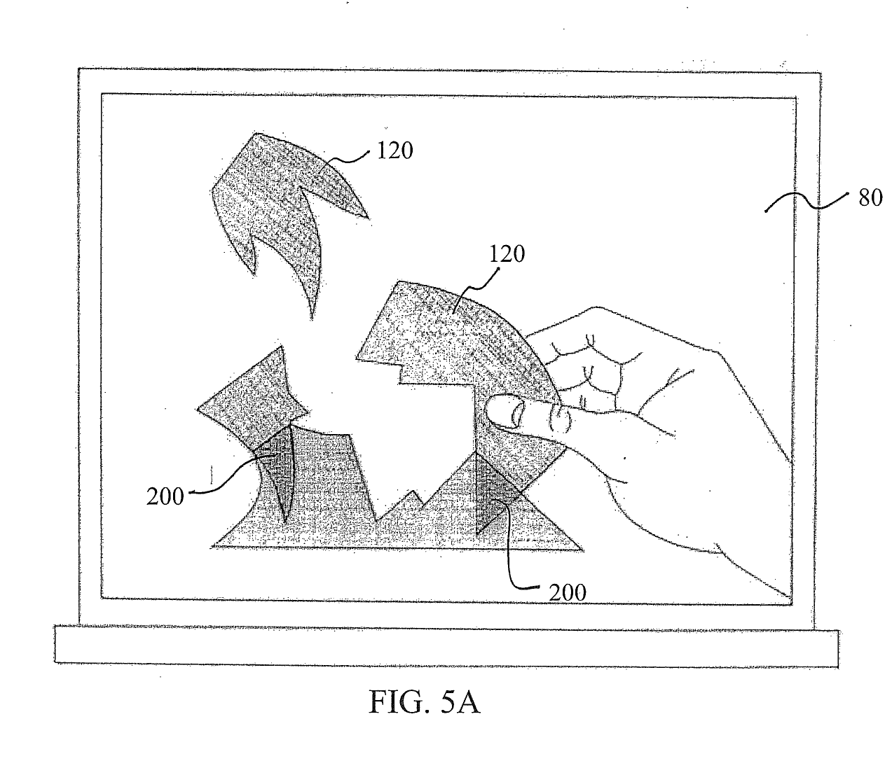

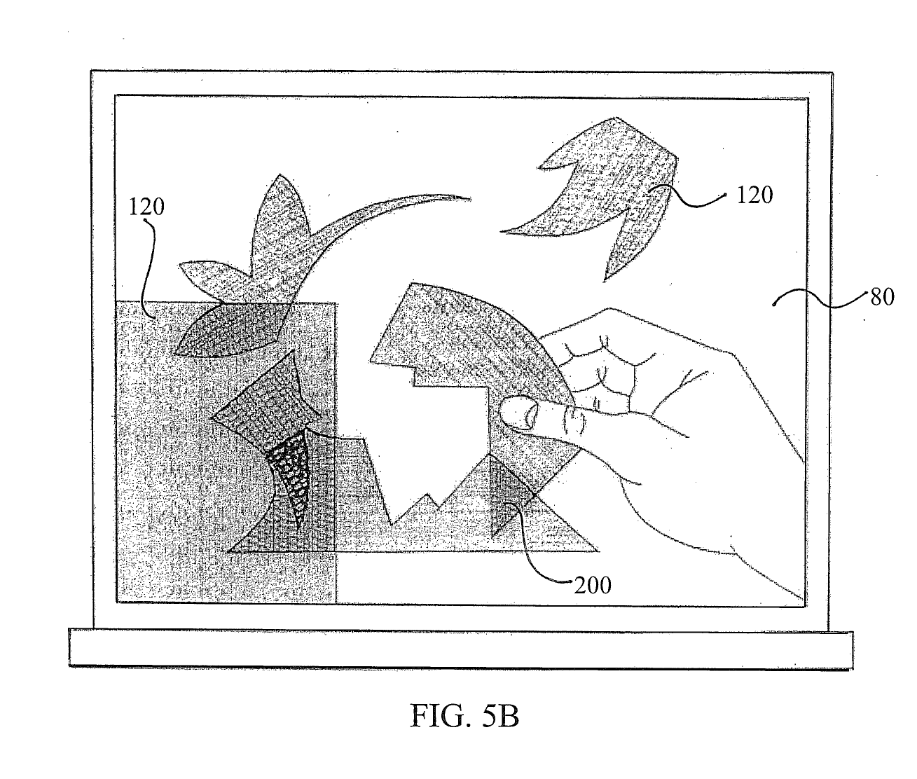

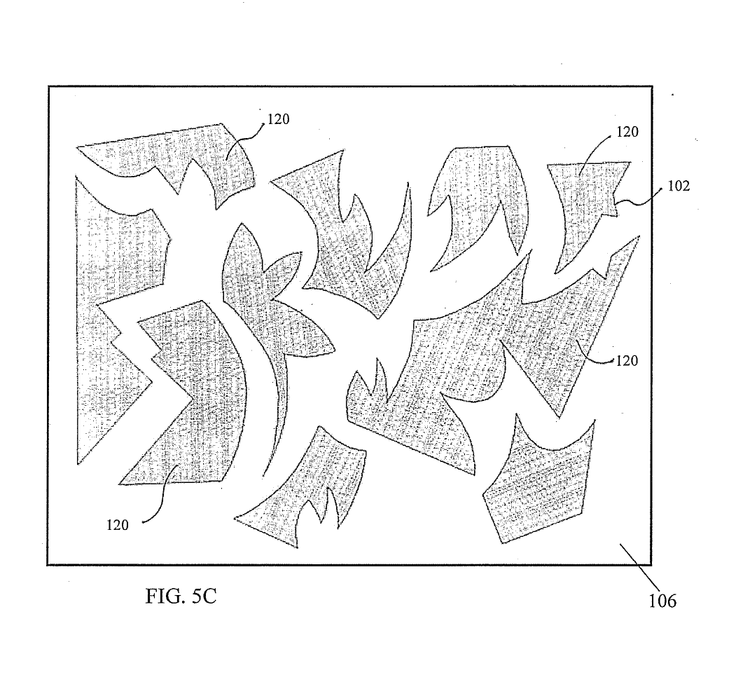

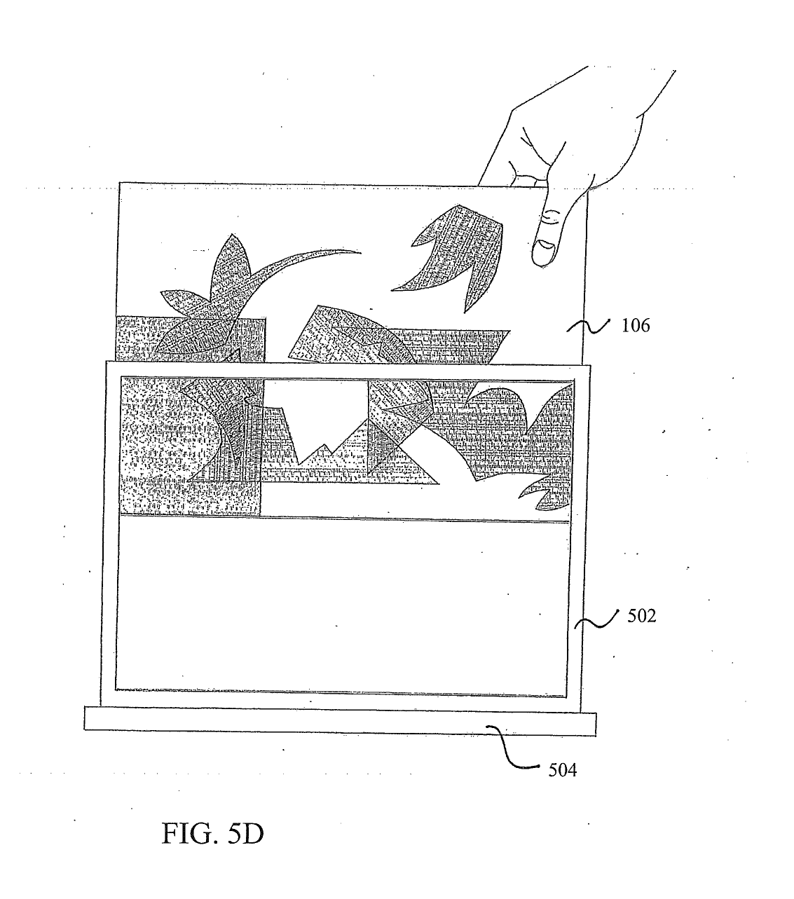

FIGS. 5A and 5B are representative views of method of use of window decoration kit of the present invention 100 showing overlapping of cut-outs 120. As best shown in FIGS. 5A and 5B, users can apply the present invention 100 on the inside or outside of any window or glass panel. Recommended application steps are as follows:
1. Choose a window/glass panel 80. User should choose a window/glass panel 80 that they want to decorate. For example, a west-facing window will create an afternoon and late afternoon cast of light and an east-facing window will cast the morning light. A south-facing window will provide a back-lit window in places in the northern hemisphere, depending on the angle of the sun. Bright colors will bring warmth to a north-facing window but not necessarily cast direct sunlight. Typically, windows decorated according to kit and method steps of the present invention will look best from the inside and will create privacy for the inside from the outside. Decorative effects will alter as light changes at different times of day and different times of year. In addition, window/glass panel 80 of essentially any size can be decorated with the decoration kit 100 of the present invention.
2. Wash the window prior to use. Prior to use, users need to wash the application surface of the window/glass panel 80 being used with any suitable window cleaner, and let it dry prior to use. This will facilitate the adhesion of cut-outs 120 and colored die-cut film 104 on said surface of the glass panel 80.
3. Apply each of the large rectangular colors first. Although it is not mandatory, users can start placing a colored die-cut film 104 with no design pattern 110 of any color as a background. This process creates a base that unifies the colors and help holds the subsequently applied cut-outs 120 in place. Start by placing a right angle of any large rectangle of color in the corner of the window. Other ways to provide an overall background will be apparent to those skilled in the art.
4. Use a brayer to flatten. With the unique material of construction of the colored die-cut film 104 and cut-outs 120, they can be adhered on the application surface of the window/glass panel 80 easily. In the event that there are air bubbles trapped between cut-outs 120 and the window/glass panel 80 that can't be removed by hand, they can be easily removed by running a brayer or other roller device over the area.
5. Place the large rectangles in the other three corners. These can be used along the remaining sides of the window/glass panel 80, overlapping the previous cut-outs 120 and create additional colored shapes 200 by overlapping cut-outs 120 of different colors.
6. Place larger cut-outs 120 over cut-outs 120 of different geometric shapes, overlapping several colors at once to create new colored shapes 200.
7. Continue to place cut-outs 120 of different sizes and shapes, overlapping each other and braying when needed. Users can use as many, or as few, shapes of cut-outs 120 as they like.

In one embodiment, cut-outs 120 are reversible, i.e., both sides of cut-outs 120 and colored die-cut film 104 can be applied and automatically cling on to any clean window/glass panel 80, clear acetate film 106, plexiglass and each other without any adhesive and/or chemicals. The force of adhesion between the window/glass panel 80 and cut-outs 120 is created by apparent static charge and ambient air pressure. Using typical material of construction, light weight, and optimum thickness of cut-outs 120 of between 0.009″ to 0.012″, cut-outs 120 can be adhered to window/glass panel 80 without any supplemental adhesive or chemicals. Besides, since cut-outs 120 are extremely light in weight, they will not fall off the window/glass panel 80 easily if all air-bubbles are squeezed out or otherwise removed. As best shown in FIGS. 5A and 5B, due to the unique material of construction and physical nature of cut-outs 120 and colored die-cut film 104, users can freely apply cut-outs 120 of different shapes and color, overlapping two or more cut-outs 120 either partly or completely to create new colored shades and shapes 200 to enhance their own design. For example, overlapping red and blue cut-outs 120 will create a purple shade 200. Additionally, cut-outs 120 can be peeled off from window/glass panel 80 easily without causing damage both to the window/glass panel 80 and to cut-outs 120 since no adhesives were applied. Users can freely add, subtract, reposition, overlap, reapply both sides of any cut-outs 120 and colored die-cut film 104 for as many times as they wish, until they are satisfied with their final design, and they can change their design as frequently as they wish.

FIGS. 5C and 5D are representative views of an alternative method of use of window decoration kit of the present invention 100. Instead of placing cut-outs 120 directly on window/glass panel 80 to create a final design as described in FIGS. 5A and 5B, users can create their desirable design by placing cut-outs 120 on clear acetate film 106, as best shown in FIG. 5C. Users can simply utilize clear acetate film 106 as a canvas for their design by placing and repositioning cut-outs 120 on it until a final design is attained. Subsequently, users can position and press clear acetate film 106, having the cut-outs 120 adhered on top of it, against a window/glass panel 80. Users can then carefully peel off the clear acetate film 106 and a mirror image of the final design they created on the clear acetate film 106 will be adhered to the window/glass panel 80. Alternatively, as best shown in FIGS. 5C and 5D, users can also retain the final design they created on the clear acetate film 106 by framing it. In one embodiment, frame 502 is a picture frame with or without a stand or holder 504 made of card board, wood or other light materials with compatible size to clear acetate film 106. User can optionally place another piece of clear acetate film on top of clear acetate film 106 to protect the final design before framing it.

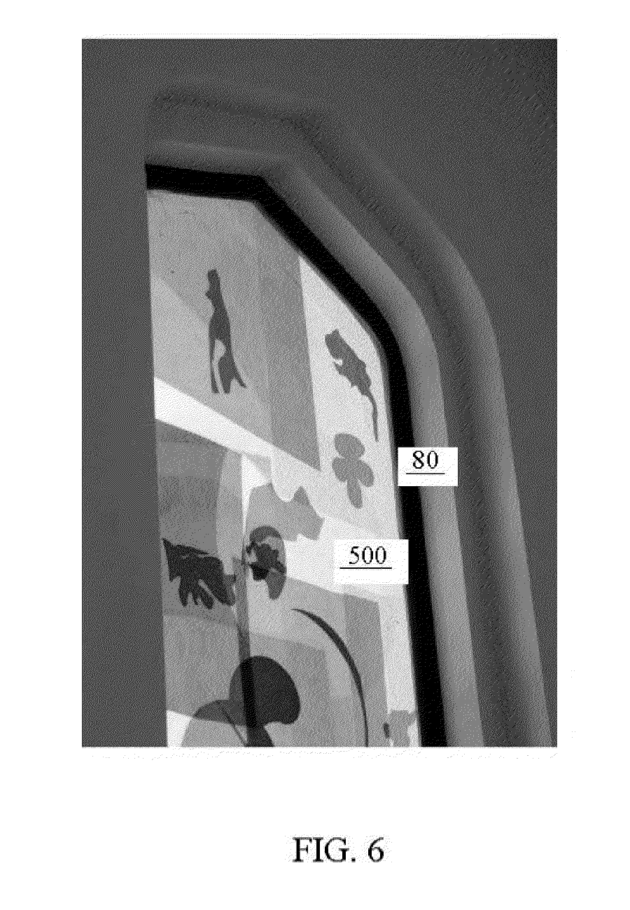

FIG. 6 is a representative view of method of use of window decoration kit of the present invention 100 showing the completed window decoration 500 on a window 80. It shows overlapping of cut-outs 200, empty spaces with cut-outs 120, application of colored die-cut film 104 without any design pattern and combination thereof to create a unique design for window decoration 500.

Window decoration kit 100 of the present invention can be transformed into a puzzle game. Users first disengage all cut-outs 120 of colored die-cut film 104, flip some or all cut-outs 120 and then assemble the complete colored die-cut film 104 on the clear acetate film 106 according to its original design 110. To lower the level of difficulty for younger people, the paper backing 108 which has the tracing of the design pattern 110 can be placed underneath the clear acetate film 106 so users can assemble the design pattern 110 more easily.

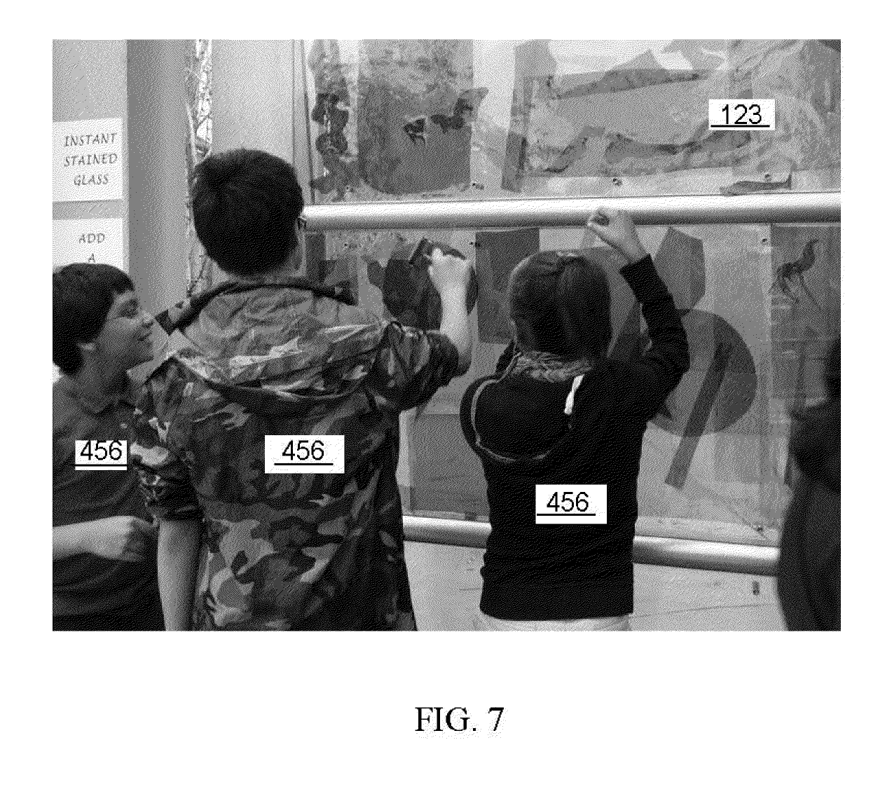

FIG. 7 is a representative view of method of use of window decoration kit of the present invention 100 utilized as an interactive educational instructional game 123. Alternatively, window decoration kit 100 can be transformed into an interactive education tool for 2-D design. The instructor can ask participants 456 to put cut-outs 120 of different sizes and shapes on a clean window/glass panel or clear acetate film 106. Participants 456 can add, take out, overlap, reposition cut-outs 120 and the instructor can explain the related theory(ies) of color, abstraction, design elements, figure/ground relationship, positive and negative space, composition, balance, process and science of light.

Sample “Window Decoration Kit Components”

List of Kit Elements:
1. Six 8½×11″ designs pre-cut in vinyl (one in each color: crimson, orange, pink, purple, blue, green) adhered to clear acetate
2. Six 8½×11″ designs on paper (one for each color) (behind each pre-cut vinyl sheet)
3. Six 8½×11″ plain sheets of vinyl (with white interleaving paper)
4. Written Instructions
5. Clear Envelope
6. Label TBD
7. Recommended Accessory: Brayer, Speedball 2.5″ soft rubber roller
8. Packaging box

Description of Materials:
12 Gauge Tinted Clear Plastic Vinyl: 54″ wide
RTV 12 Red
OTV 12 Orange
PTV 12 Pink
PUR 12 Purple
BTV 12 Blue
GTV 12 Green

### Also Available:

CTV 12 Crimson
YTV 12 Yellow
STV 12 Smoke

Sample “Window Decoration Kit” Written Instructions—I

One kit covers approximately 30″×30″ or three square feet of window area. Multiple kits can be combined to cover larger areas.
1. Choose a window. A west-facing window will create late afternoon cast light. An east-facing window will cast morning light. A south-facing window will provide some cast light depending on the angle of the sun. Bright color will bring warmth to a north-facing window but no cast light. The window will look best from the inside and will create privacy from the outside. Notice how the light changes at different times of day and different times of year.
2. Wash the window
3. Apply each of the large rectangular colors first. This process creates a base that unifies the colors and holds the smaller shapes in place. Start by placing a right angle of any large rectangle of color in the corner of the window.
4. Use the brayer to flatten and remove the air bubbles under each cut-out as you go.
5. Place the large rectangles in the other three corners and along the remaining sides of the window, overlapping the previous shapes. Notice the additional colors created by overlapping.
6. Now have fun placing the larger cut design shapes over the geometric shapes, overlapping several colors at once to create new shapes.
7. Apply the smaller shapes, overlapping and braying as you go.
8. Use as many, or as few, shapes as you like. Rearrange, add, subtract.

### HAVE FUN. THERE ARE INFINITE SOLUTIONS AND NO WRONG ANSWERS. ENJOY!

Sample “Window Decoration Kit” Written Instructions—II

Color Play without a Window
1. Putting the colored shapes away becomes a puzzle. Match each of the shapes to the paper design underneath.
2. To create an even bigger challenge, put each of the colors back in place WITHOUT the design underneath.
3. Use one sheet of clear acetate (over a white sheet of paper) as a base for creating a composition using any variety of cut shapes. Play with overlapping shapes to create multiple colors and compositions.

a.) Then, one at a time, place each large rectangle of color behind the composition as background. Notice how the composition changes when the background color changes. What happens when you put the background color on top?

b.) This composition on clear acetate can also be placed in a window by pressing the cut shape side directly to the window and removing the clear acetate sheet.

Teaching Concepts
Color Theory
Abstraction
Design Elements
Figure/Ground Relationship; Positive/Negative Space
Composition
Balance
Process
Science of Light

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A window decoration kit for adding various tinting effects to a back-lit window or other transparent panel, the window decoration kit comprising a plurality of colored film sets of different colors, each colored film set further comprises:
a colored vinyl film having a pre-determined size and shape and made with 9 to 12 gauge fluorescent tinted clear plastic vinyl, the colored vinyl film further having a predetermined thickness, a primary color and a design pattern, further die-cut along the design pattern such that a plurality of cut-outs of different shapes and sizes produced therefrom, either side of cut-outs to be applied and adhere to the window, the plexiglass panel and the glass panel without the use of adhesive;
a clear acetate film having a predetermined size and shape placed underneath the colored vinyl film such that the static charge between the colored vinyl film and the clear acetate film holds the cut-outs in place; and
a white paper backing having a predetermined size and shape placed underneath the clear acetate film, the paper backing further having the design pattern printed thereon.

2. The window decoration kit of claim 1 in which the primary color of each colored vinyl film selected from the group of:
red, orange, pink, purple, blue, green, crimson, yellow, and smokey grey.

3. The window decoration kit of claim 1 in which the predetermined thickness is between an approximate range of 0.005″ to 0.015″.

4. The window decoration kit of claim 1 in which the predetermined thickness is between an approximate range of 0.009″ to 0.012″.

5. A method of decorating a back-lit window or glass panel to create tinting effects, the method of decorating a window or a glass panel further comprising:
i. choosing a window or a glass panel for decoration;
ii. cleaning the inside of the window or the glass panel;
iii. obtaining a window decoration kit comprising a plurality of colored film sets of different colors, each colored film set further comprises a colored vinyl film having a predetermined size and shape made with 9-12 gauge tinted clear plastic vinyl, the colored vinyl film further having a primary color and a design pattern, further die-cut along the design pattern such that a plurality of cut-outs of different shapes and sizes produced therefrom, a clear acetate film having a predetermined size and shape placed underneath the colored vinyl film such that the static charge between the colored vinyl film and the clear acetate film holds the cut-outs in place, a white paper backing having a predetermined size and shape placed underneath the clear acetate film, the paper backing further having the design pattern printed on;
iv. peeling off and picking up one of the colored cut-outs from the colored vinyl film and applying it on the window or the glass panel directly without using adhesives, using a brayer to remove air bubbles if necessary;
v. adding one or more colored cut-outs on the window or the glass panel, partly or completely overlapping other colored cut-outs,
vi. repositioning and overlapping the colored cut-outs to create a window design;
vi. peeling off one or more colored cut-outs from the window or the glass panel, repositioning colored cut-outs to adjust the window design;
vii. repeating steps iv to vi for one or more times until a final window design is achieved.

6. The method of decorating a window or a glass panel of claim 5 further comprises:
viii. peeling off and picking up one of the colored cut-outs from the colored vinyl film and applying it on the clear acetate film directly without using adhesives, using a brayer to remove air bubbles if necessary;
ix. adding one or more colored cut-outs on the clear acetate film, partly or completely overlapping other colored cut-outs,
x. repositioning and overlapping the colored cut-outs to create a design;
xi. peeling off one or more colored cut-outs from the clear acetate film, repositioning colored cut-outs to adjust the design;
xii. repeating steps ix. to xi. for one or more times until a final design is achieved on the clear acetate film;
xiii. pressing the clear acetate film with the final design against the window or the glass panel, carefully peeling off the clear acetate film and leaving a mirror image of the final design on the window or the glass panel.

7. A method of education of 2-D design using a back-lit window or a glass panel or a clear acetate film, the method of education of 2-D design further comprising:
i. obtaining a window decoration kit comprising a plurality of colored film sets of different colors, each colored film set further comprises a colored vinyl film having a predetermined size and shape and made with 9-12 gauge tinted clear plastic vinyl, the colored vinyl film further having a primary color and a design pattern, further die-cut along the design pattern such that a plurality of cut-outs of different shapes and sizes produced therefrom, a size and shape placed underneath the colored vinyl film such that the static charge between the colored vinyl film and the clear acetate film holds the cut-outs in place, a white paper backing having a predetermined size and shape placed underneath the clear acetate film, the paper backing further having the design pattern printed on;
ii. requesting students to peel off and pick up one of the colored cut-outs from the colored vinyl film and apply it on the window or the glass panel or a clear acetate film directly without using adhesives, using a brayer to remove air bubbles if necessary;
iii. requesting students to add one or more colored cut-outs on the window or the glass panel, partly or completely overlapping other colored cut-outs;
iv. requesting students to reposition and overlap the colored cut-outs and observe the change in colors, shapes, tinting effects;
v. explaining to students the theory of color theory, abstraction, design elements, figure and ground relationship, positive and negative space, composition, balance, process and science of light.
